(19) United States
(12) Patent Application Publication
(10) Pub. No.: US 2020/0200530 A1
(43) Pub. Date: Jun. 25, 2020

(54) INTEGRAL MAGNET MOUNT FOR GOLF RANGING DEVICE

(71) Applicant: Bushnell Inc., Overland Park, KS (US)

(72) Inventors: Scott O. Nyhart, Shawnee, KS (US); John DeCastro, Overland Park, KS (US)

(21) Appl. No.: 16/231,215

(22) Filed: Dec. 21, 2018

(51) Int. Cl. G01C 3/08; A63B 57/00; A63B 71/06

(52) U.S. Cl. CPC G01C 3/08; A63B 57/00; A63B 2102/32; A63B 2220/805; A63B 71/0622

(57) ABSTRACT

A golf laser rangefinder comprises a housing with a pair of opposing side wall portions. One of the side wall portions has a magnetic attraction strip extending diagonally across the side wall portion for attachment to, for example, an upright roof support member of a golf cart. A display on the side wall portion opposite the magnetic attraction strip can provide data display, including real time data, to the driver or passenger of the golf cart when the laser rangefinder is mounted to the support member.

### BACKGROUND OF THE DISCLOSURE

Unlike sports such as baseball, tennis, soccer and football, the sport of golf does not use a standardized playing area. Accordingly, the player's ability to cope with the varied terrains encountered on different golf courses is an important part of game strategy. Tools at a player's disposal include golf course maps, GPS devices and laser rangefinders for making measurements while on the golf course. A golf course typically consists of either 9 or 18 holes with each hole having a cup surrounded by a putting green. A flagstick or “pin” is received in the cup making the location of the cup visible from a distance. Each hole also includes a teeing region or “tee box” that is set off with two markers showing the bounds of the legal tee area. A fairway extends between the tee box and the cup.

A variety of obstacles and hazards are typically placed between the tee box and the pin. These obstacles and hazards may including sand bunkers, trees, ponds, lakes, rivers, shoreline, creeks, un-grassed areas, and natural vegetation areas, which are typically located on the sides of fairways but may be place in the fairways. Generally, the fairway is far from perfectly flat and may have significant undulations and changes in elevation, sometimes the elevation differential between the golf ball striking location and the landing spot, such as the green, can be significant. Golfers strive to shoot low golf scores, that is, going from tee to cup in a minimal number of strokes.

Within recent decades, laser rangefinders were introduced to the game of golf. Laser range finders can provide highly accurate measurements to pins, hazards and intermediate landing spots. Distances are graphically displayed in the viewfinder of the range finder. Initially laser rangefinders were utilized solely for measuring actual laser ranged distances, for example to a flagstick or a hazard. Although that is clearly still their principle use today, it is known to equip laser rangefinders with additional functionalities. For example, providing in addition to displaying measured laser ranged distances, also displaying “play as” distances where the measured distance is adjusted to compensate for such things as changes in elevation, wind, altitude, and temperature. The rangefinders utilizing internal algorithms and processors to make the calculations and suitable adjustments.

Laser range finders originally had significant issues discriminating trees and other objects from the flagsticks. These issues have been addressed to some extent by utilizing algorithms and software with processors to identify flag acquisition internally by the laser rangefinder processors and then by visually indicating to the user that the flagstick or other object has been identified with some certainty by the rangefinder. Typically such a pin acquisition indicator has been by way of an icon appearing in the middle of the display or in the central portion of the display, or with labels, such as TARGET ACQUIRED appearing in the central portion of the display.

Apart for laser rangefinders, GPS devices are utilized for providing distance assistance to aid golfers. Such devices store golf course layouts and with the GPS device establishing the location of the range finder and with the course layout stored in the GPS device, the device can calculate the distances to the middle, front, and rear of the green on the current hole. Laser ranging can be supplemented with location information provided by GPS. For example, combining a laser range finder with the GPS can give a distance to the flag stick and then can add the GPS calculated distances to the front and rear of the green. Such laser rangefinders are known.

Accomplished golfers consider many variables on each shot, especially shots to the green, and to the extent data and information is available through the electronic devices, such data and information is welcome. Such information and data can help golfers determine club selection, where to hit the ball, and even how to hit the ball.

A further consideration in golf is the pace of play. Maintaining a good pace of play is one of the main rules of golf etiquette. At times this is very important as a slow player or players can back up an entire course and disrupt scheduled tee times. Playing partners and groups behind slow players seriously frown upon slow play. Slow play can result by players taking too long to line up shots, considering which club to hit, assessing the many variables, such as wind, elevation differences, potential landing spots, and risks of off-line shots. Properly and expediently assessing all these variable is necessary for shooting low scores and keeping up with the pace of play.

Players that take too long to line up shots, or in considering which club to hit, or in taking too many practice swings are frowned upon. There is a very real need of providing data to the golfer through the laser range finder quickly and clearly so as not to inhibit the pace of play.

In lining up a shot, either off of the tee, or between the tee and green, golfers may often think the more data the better. The viewfinder in sophisticated golf rangefinders may end up being flooded with data, including data such as: actual distance to pin, distance to the front of the green, distance to the rear of the green, play as distance, battery life, hole being played, and other information. To the extent that the data and information presentation is user friendly and quickly accessible, pace of play may be improved.

Vital data and information can be conveyed to the golfer when a golf laser rangefinder is readily accessible. A brisk pace of play can be maintained when the golf laser rangefinder is readily stowable so as to be out of the way while the golfer is addressing the ball. Accordingly, features that allow the golf laser rangefinder to be easily stowable and readily accessible would be welcomed by golfers.

### SUMMARY

In embodiments, a golf laser rangefinder comprises a housing supporting a viewfinder, a push button laser actuator, an eyepiece, a display viewable through the eyepiece with information and data provided on the display, and one or more magnets on a lateral side of the housing. The information includes a measured distance readout and may include additional information such as “play as” distance, battery information, hole being played information, distance to front of green, and distance to back of green.

A feature and advantage of embodiments is a golf laser rangefinder comprising a housing and one or more magnets supported by the housing. The one or more magnets allow the golf laser rangefinder to be quickly stowed as magnetic force from the magnet fixes the golf laser rangefinder to a ferromagnetic object such as a portion of a golf cart. The one or more magnets allow the golf laser rangefinder to be stowed in a manner and location that makes the golf laser rangefinder readily accessible and visible immediately in front of the golfer, for example on an upright golf cart roof support rail.

A feature and advantage of embodiments is a golf laser rangefinder comprising a housing and a pair of magnets supported by the housing, the pair of magnets including a first magnet and a second magnet spaced apart from one another such that the magnets are positioned in opposing corners of a generally rectangular lateral side of the laser rangefinder housing. In embodiments, the distance between the first magnet and the second magnet maximized to provide greater mounting stability when the golf laser rangefinder is fixed to a ferromagnetic object such as a portion of a golf cart, for example a forward roof support member.

A feature and advantage of embodiments is a golf laser rangefinder comprising a housing and a pair of magnets supported by a side wall that includes a smooth outer surface for easy cleaning and for reducing the likelihood that debris will collected. In embodiments the housing arrangement minimizes component connection joints that can accumulate and trap dirt and debris. In embodiments, the side wall supporting the pair of magnets includes no grooves to collect debris.

A feature and advantage of embodiments is a golf laser rangefinder comprising a housing and a pair of magnets disposed along an orientation line arranged for locating the golf laser rangefinder at a predetermined orientation. In embodiments, the predetermined orientation is selected to reduce the likelihood that sensitive internal components will be damaged by radiation from the sun. In embodiments the magnets are aligned on a line extending between opposing corners of a generally rectangular lateral side wall of the laser rangefinder housing.

A feature and advantage of embodiments is a golf laser rangefinder comprising a housing and one or more magnets, the one or more magnets being positioned on an opposite lateral side of the housing from the lateral side with a display screen and operating button so that the screen can be viewed when the laser golf rangefinder is mounted on a surface in a golf cart forward of the golfer. Moreover, when so mounted, immediate physical and visual access is provided to the lateral side controls of the golf laser range finding device.

A feature and advantage of embodiments is a golf laser rangefinder including a direction indicating element for indicating a desirable orientation for the golf laser rangefinder to assume when stowed. In embodiments, the direction indicating element is arrow-shaped.

A feature and advantage of embodiments is a golf laser rangefinder including a housing with a lateral side that has a central screen and operating button as the periphery of the screen. This arrangement may facilitate holding the golf laser rangefinder in the palm of one hand and pushing the buttons with the other hand while viewing the screen. Magnets are positioned on the opposite lateral side, allowing the user to view the lateral side screen, operate the device, and then mount the device with the screen facing outwardly with the operator never taking his eyes off of the information provided on the screen. This can be advantageous as the display is giving a yardage readout that is changing as the golf cart approaches a ball location. Such also permits the golf cart occupant to keep his eyes forward while the cart is moving reducing any chance of a golf cart accident.

A feature and advantage of embodiments is a golf laser rangefinder including orientation sensor for detecting a present orientation of the housing. In embodiments, a display on the golf laser rangefinder provides a visual indication that the housing is in a desired orientation based on a signal from the orientation sensor. In embodiments a lateral side of the rangefinder, opposite the side with the magnetic attraction region, may have indicia providing proper alignment indication of the rangefinder to facilitate the alignment as it is being placed on the upright support member on a golf cart. The alignment indicator parallel to the magnetic attraction region.

A feature and advantage of embodiments is that the golf laser rangefinder is be readily stowable so that it is out of the way when not needed. A feature and advantage of embodiments is that the golf laser rangefinder is readily accessible, so as to be quickly and easy retrieved from a stowed position saving time on the golf course and facilitating pace of play. A feature and advantage is that the magnets are permanently attached to the housing.

An example laser rangefinder may include a housing supporting an objective optic, an eyepiece optic, and a view-thru display. The view-thru display may be located along an optical path between the objective optic and the eyepiece optic. In embodiments, the view-thru display comprises a first transparent sheet and a plurality of electrodes disposed on a first inner surface of the first transparent sheet. The view-thru display may be disposed rearward of the objective optic and the eyepiece optic may be disposed rearward of the view-thru display assembly so that a scene or subject can be viewed through the eyepiece optic and a plurality of display elements selectively displayed by the view-thru display assembly are superimposed on the scene or subject being viewed. Information regarding playing conditions in proximity to the laser rangefinder may be presented on the view-thru display. The view-thru display may comprise, for example, an LCD display and/or an OLED display.

A feature and benefit of embodiments is a golf cart mountable laser rangefinder that displays information on a view-thru display and a side display, the side display viewable to drivers and passengers in the golf cart.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A is a stylized perspective view showing a laser rangefinder and a golf cart in use on a golf course.

FIG. 1B is an enlarged detail view showing the laser rangefinder and the golf cart shown in FIG. 1A.

FIG. 1C is an enlarged detail view showing the laser rangefinder shown in FIG. 1B.

FIG. 2 is a perspective view of a laser rangefinder in accordance with an example embodiment.

FIG. 3 is an exploded perspective view of a laser rangefinder in accordance with an example embodiment.

FIG. 4 is a perspective view of a laser rangefinder in accordance with an example embodiment.

FIG. 5A is a perspective view showing the positioning of two magnets on a laser rangefinder housing.

FIG. 5B is a perspective view showing a different positioning of two magnets on a laser rangefinder housing.

FIG. 5C is a perspective view showing a different positioning of an elongate magnet on a laser rangefinder housing.

FIG. 5D is a perspective view showing different positioning of magnets on a laser rangefinder, with the magnetic attraction region constituting essentially the entire lateral side of the laser rangefinder.

FIG. 5E is a perspective view showing a display on a lateral side of a laser rangefinder, the side opposite the side with a magnetic attraction region.

FIG. 5F is a perspective view showing a an indicator or indicia that provides an alignment guide of the rangefinder for placement on an upright roof support member of a golf cart.

FIG. 6 is a perspective view of a laser rangefinder and a stylized view illustrating the view seen through the eyepiece optic of the laser rangefinder.

FIG. 7A through FIG. 7F are elevation and plan views showing six sides of a laser rangefinder having a housing.

FIG. 8 is a diagram illustrating a laser rangefinder in accordance with the detailed description.

FIG. 9 is a diagram illustrating a laser rangefinder in accordance with the detailed description.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

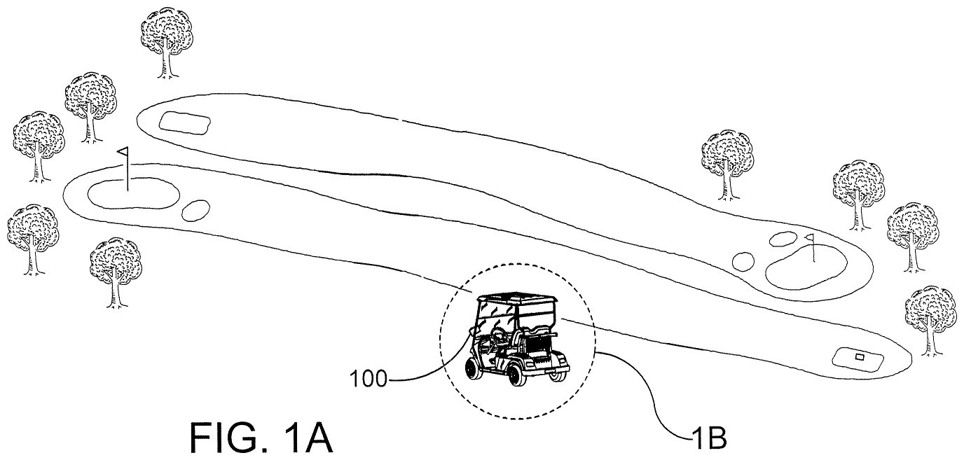

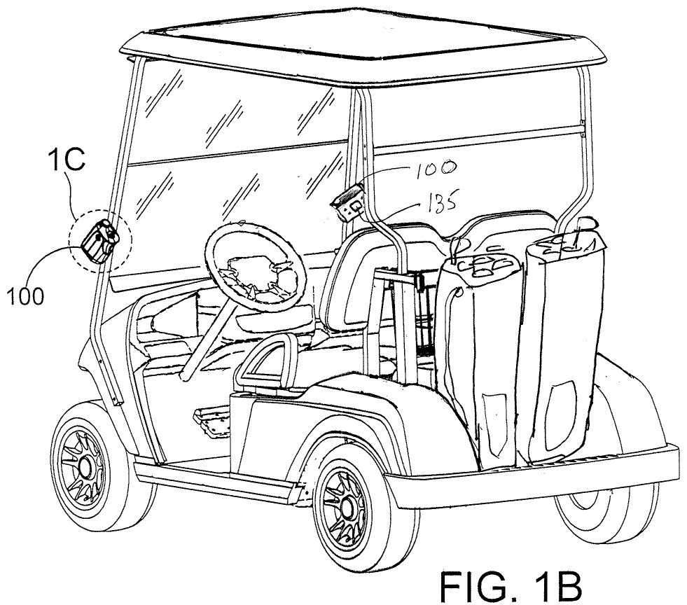

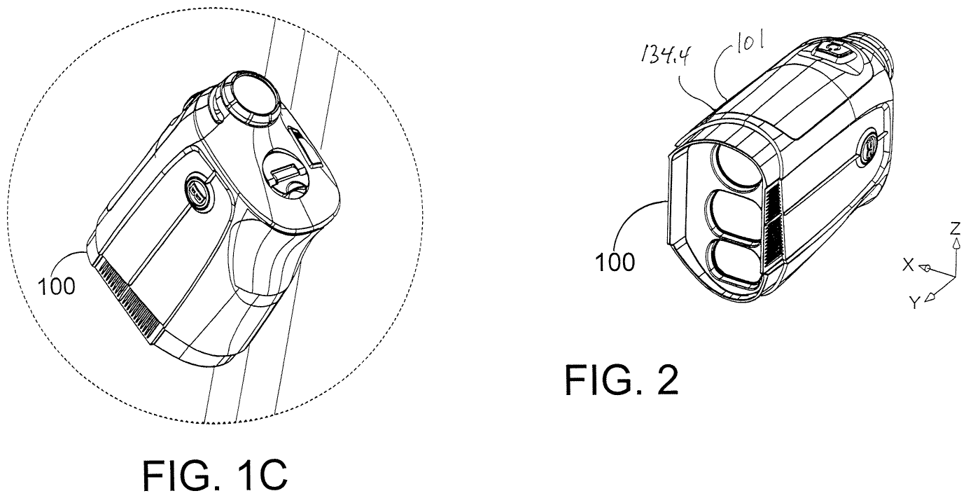

Referring to FIGS. 1A-2, a golf cart 90 with upright roof support members 92 removably receives a golf laser rangefinders 100 with a magnetic attraction regions 101. In embodiments, the golf laser rangefinder has a viewfinder, a push button laser actuator, an eyepiece, and a display viewable through the eyepiece with information and data provided on the display. The information includes a measured distance readout and may include additional information such as “play as” distance, battery information, hole being played information, distance to front of green, and distance to back of green.

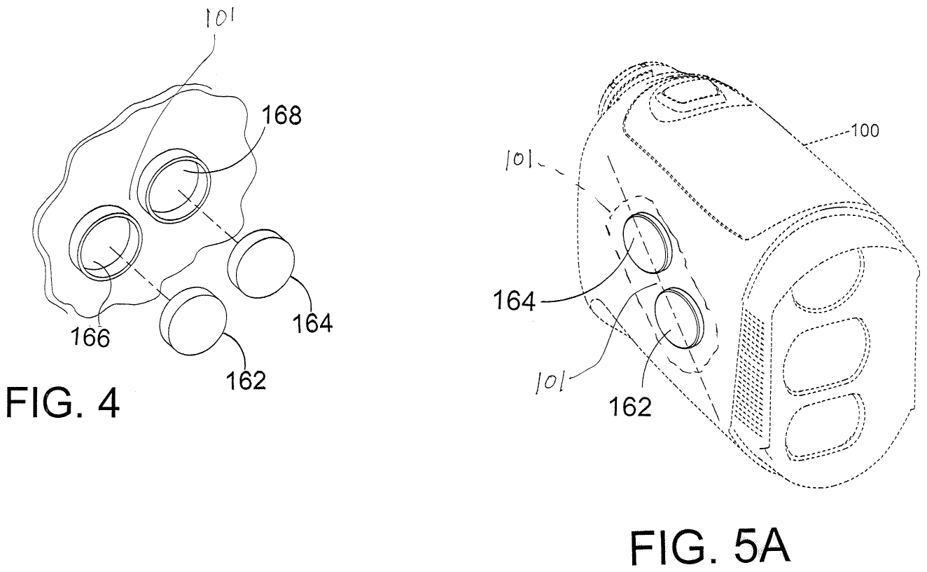

Referring to FIGS. 1C to 5D, in embodiments, the golf laser rangefinder 100 comprises a housing 102 supporting an objective optic 104, an eyepiece optic 106, and a view-thru display assembly 108. The objective optic 104 may comprise one or more objective lenses 110 and the eyepiece optic 106 may comprise one or more eyepiece lenses 112. The view-thru display assembly 108 may be located along an optical path 114 between the objective optic 104 and the eyepiece optic 106. The view-thru display assembly 108 may be disposed rearward of the objective optic 104 and the eyepiece optic 106 may be disposed rearward of the view-thru display assembly 108 so that a scene or subject can be viewed through the eyepiece optic 106 and a plurality of numbers, letters, and/or icons may be selectively presented on the view-thru display assembly and superimposed on the scene or subject being viewed. Various information may be presented on the view-thru display assembly 108 without deviating from the spirit and scope of this detailed description. The view-thru display assembly 108 may comprise, for example, an LCD display assembly and/or an OLED display assembly.

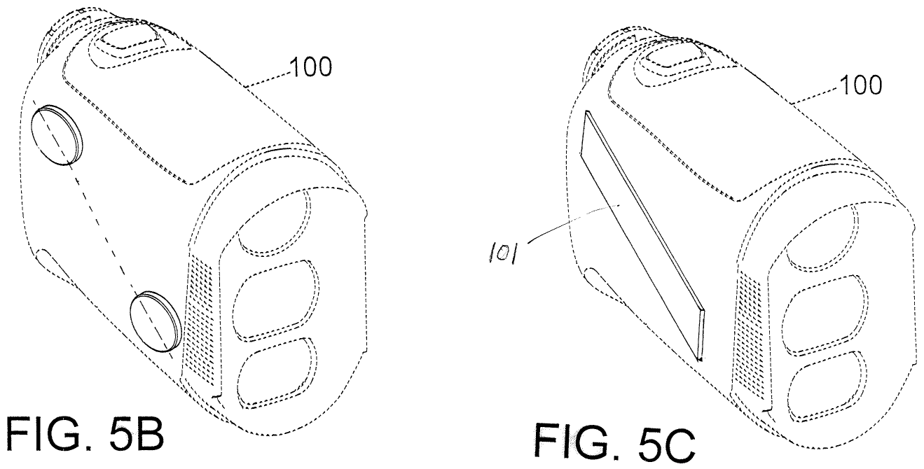

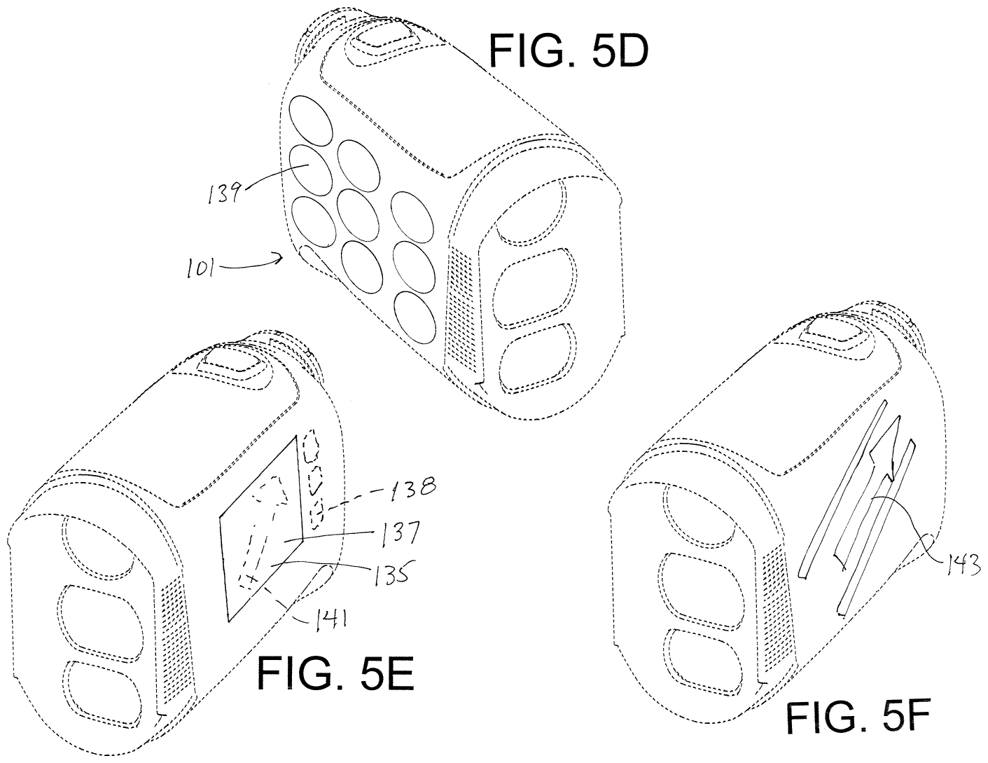

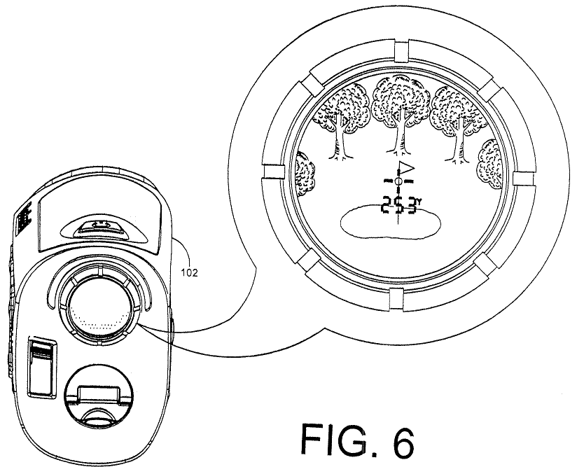

Referring still to FIGS. 1C to 5D, the housing 102 includes a pair of opposing housing wall portions 130, 131, each housing portion having a side wall portion 132, 133. The housing defines a cavity 160. One of the side wall portions may define a first pocket 166 and a second pocket 168. The pockets can be defined on an inside surface 134.2 or an outside surface 134.4 of the side wall portion 132. The other of the side wall portions may have a display 135 with the housing side wall portion 133 defining a display window 136 with a display screen 137 framed therein and with control buttons 138 adjacent thereto. In embodiments, magnetic attraction region 101 is the golf ranging devices includes a set of magnets configured as a pair of magnets comprising a first magnet 162 received in the first pocket 166 and a second magnet 164 received in the second pocket 168. In embodiments, the display screen 137 is supported in the housing 102 at a location inside the cavity 160 so that the display is visible through the display window 136. The positioning of the set of magnets 139 opposite the display screen 137 allows the golfer sitting in the golf cart to view the display when the laser rangefinder is mounted to an upright support post, see the passenger side of the cart depicted in FIG. 1B. Referring to FIG. 5D, the magnets can be distributed and placed, either interiorly or exteriorly on the housing such that the magnetic attraction region 101 covers essentially or the entire side wall portion 132 rather than a diagonal strip.

The display screen 137 may provide, for example, GPS position date, such as distance from the rangefinder to the front of the green, the middle of the green, and the backside of the green. Such can be visible to the golf cart riders when mounted on a golf cart. In embodiments the display screen can also provide an indicator 141 to the user as to positioning of the magnetic attraction region on the opposite side of the laser rangefinder, see FIG. 5E, to aid the user in quickly aligning the rangefinder to the upright support on the golf cart. Indicia 143 can also be fixed on the housing, when the housing is with or without a display, on the lateral side wall portion opposite the magnetic attraction region, to guide the mounting of the laser rangefinder, see FIG. 5F.

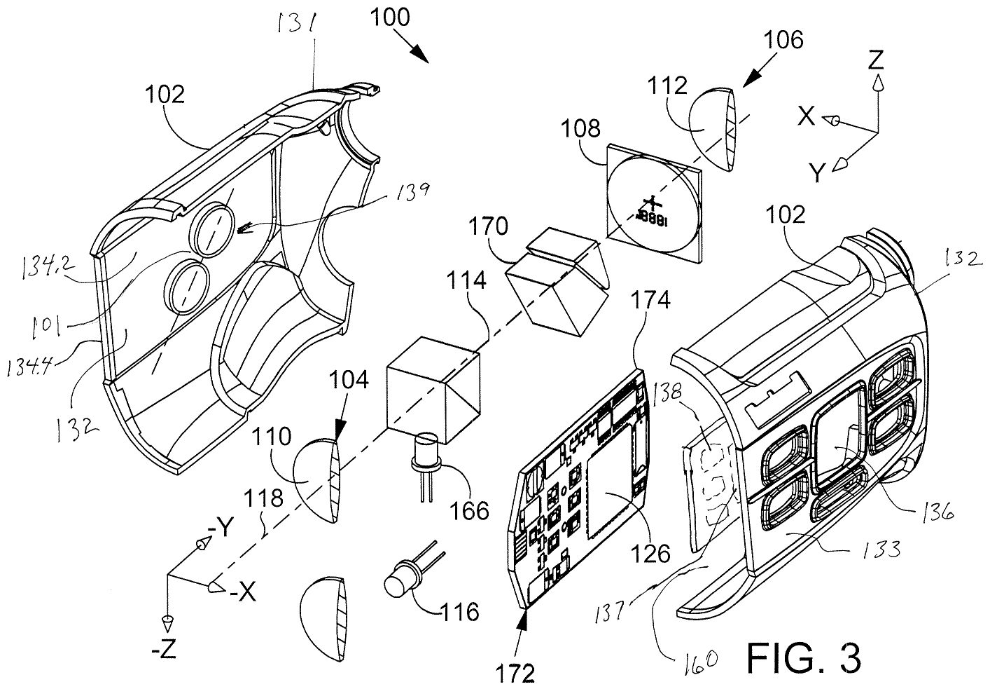

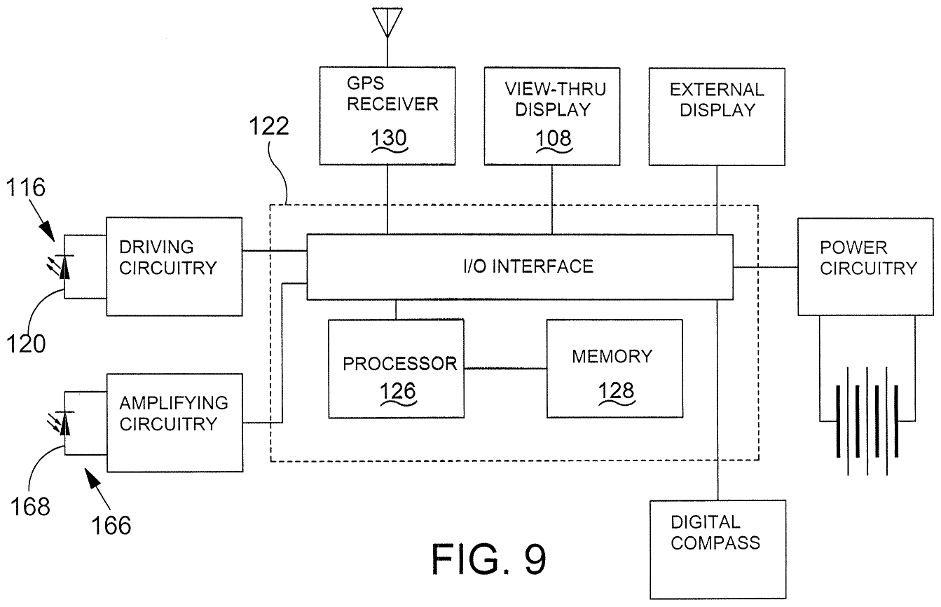

Referring still to FIGS. 3, 8, and 9, the laser rangefinder 100 may include a laser source 116 and related optics for emitting a laser beam along a laser beam axis 118. The laser source 116 may comprise a laser light emitting diode 120. The laser rangefinder 100 may also include circuitry 122 operatively coupled to the view-thru display assembly 108. In embodiments, the laser rangefinder 100 includes a digital compass 124 and a current device direction is determined by one or more processors 126 using signals from the digital compass 124. In embodiments, the device direction is aligned with the laser beam axis 118 in embodiments. In embodiments, the digital compass 124 is operatively coupled to control circuitry 122.

In embodiments, the control circuitry 122 is operatively coupled to the view-thru display assembly 108, the laser source 116 and the photo detector. In embodiments, the control circuitry comprises one or more processors and a non-transitory computer readable medium storing one or more instruction sets. In embodiments, the instructions executed by the one or more processors 126 may cause the one or more laser rangefinder 100 to measure a flight time associated for light emitted by the laser source, reflected off of a target, and sensed by the photo detector. A measured distance may be calculated based on the determined flight time. The instructions executed by the one or more processors 126 may cause the measured distance to be presented on the see-through display assembly 108 of the laser rangefinder 100.

Continuing to refer to FIGS. 3, 8 and 9, the laser rangefinder 100 may include a GPS receiver 130 for receiving information from GPS satellites and an antenna 140 operatively coupled to the GPS receiver 130. In embodiments, the GPS receiver 130 is operatively coupled to the control circuitry 122. In embodiments, the control circuitry comprises one or more processors 126 and a non-transitory computer readable medium 128 storing one or more instruction sets. In embodiments, the one or more instruction sets include instructions configured to be executed by the one or more processors 126 to determine a present location of the laser rangefinder 100 based on information received from the GPS receiver 130 and identify a database record associated with a golf hole proximate the present location of the laser rangefinder 100. The processors 126 may determine a front distance and a back distance from the identified database record. In embodiments, the front distance and the back distance are displayed on the view-thru display assembly 108.

FIGS. 3, 8 and 9 schematically illustrate a laser rangefinder 100 in accordance with this detailed description. With reference to the figures, it will be appreciated that the laser rangefinder 100 includes a printed wiring board 174 supporting the circuitry 122. In embodiments, the printed wiring board 174 comprises a substrate and the substrate supports a plurality of conductive paths 176 of the circuitry 122. In the example embodiment shown, the circuitry 122 comprises the printed wiring board 174 and a plurality of electronic components fixed to the printed wiring board 174. The circuitry 122 may comprise various elements without deviating from the spirit and scope of the present invention. For example, the circuitry may comprise combinational logic, a plurality of state machines and a clock that provides a clock signal to the combinational logic and the plurality of state machines. Each state machine may comprise state logic circuitry and a state memory. The state memory may comprise a plurality of memory elements such as flip-flops. The state logic circuitry of the state machine determines the conditions for changing the logical values of bits stored in the state memory. More particularly, the state logic circuitry of the state machine logically combines the binary values of a plurality of inputs with the binary values in the state memory representing the current state to generate a binary number representing the next state. The combinational logic circuitry may comprise various elements without deviating from the spirit and scope of the present description. For example, the combinational logic circuitry may comprise a plurality of discrete electronic components. By way of a second example, combinational logic circuitry may comprise a plurality of electronic components in the form of an application specific integrated circuit (ASIC). Examples of electronic components that may be suitable in some applications include logic gates. Examples of logic gates include, AND gates, NAND gates, OR gates, XOR gates, NOR gates, NOT gates, and the like. These logic gates may comprise a plurality of transistors (e.g., transistor-transistor logic (TTL)).

Still referring to FIGS. 3, 8 and 9, the circuitry 122 may comprise various elements without deviating from the spirit and scope of the present invention. In embodiments, for example, the circuitry 122 may comprise a processor, a memory, an input/output interface, a display, and a bus that communicatively couples the processor to the memory, the display and the input/output interface. In embodiments, the processor may comprise a collection of one or more logical cores or units for receiving and executing instructions or programs. For example, in one or more embodiments, the processor may be configured to receive and execute various routines, programs, objects, components, logic, data structures, and so on to perform particular tasks.

In embodiments, the memory is a collection of various computer-readable media in the system architecture. In various embodiments, memory can include, but is not limited to volatile media, non-volatile media, removable media, and non-removable media. For example, in one or more embodiments, the memory can include random access memory (RAM), cache memory, read only memory (ROM), flash memory, solid state memory, or other suitable type of memory. In one or more embodiments, the memory includes media that is accessible to the electronic circuitry 122. For example, in embodiments, the memory includes computer readable media located locally in the circuitry 122 and/or media located remotely to the circuitry 122 and accessible via a network. In embodiments, the memory includes a program product having a group of one or more logical instructions that are executable by the processor to carry out the functions of the various embodiments of the disclosure. In embodiments, the bus comprises one or more of any of suitable type of bus structures for communicatively connecting the electronic elements. In various embodiments the bus may include a memory bus or memory controller, a peripheral bus, and a processor or local bus using any of a variety of bus architectures.

In embodiments, the circuitry 122 includes an I/O interface coupled to a processor. The I/O interface may facilitate communication between the various components of the circuitry 122. For example, in one or more embodiments, the I/O interface may be communicatively coupled with the projector, the processor and the memory for emitting an output image via the projector. For example, in certain embodiments, the processor generates an output that corresponds to a particular pattern. The processor can transmit this output to the I/O interface which can then translate the processor output into instructions which are compatible with the projector and which result in the projector emitting light corresponding to the pattern.

In certain embodiments the I/O interface facilitates communication with input and output devices for interacting with a user. For example, the I/O interface may communicate with one or more devices such, as a user-input device and/or an external display, which enable a user to interact directly with the circuitry 122. The user-input device may comprise a keyboard, one or more push-buttons, a touch screen, or other devices that allows a user to input information. The external display may comprise any of a variety of visual displays, such as a viewable screen, a set of viewable symbols or numbers, and so on.

Referring to FIGS. 2 and 3, an upward direction Z and a downward or lower direction −Z are illustrated using arrows labeled “Z” and “−Z,” respectively. A forward direction Y and a rearward direction −Y are illustrated using arrows labeled “Y” and “−Y,” respectively. A rightward direction X and a port direction −X are illustrated using arrows labeled “X” and “−X,” respectively. The directions illustrated using these arrows are applicable to the apparatus shown and discussed throughout this application. The port direction may also be referred to as a left direction and/or the leftward direction. The rightward direction may also be referred to as a right direction. In one or more embodiments, the upward direction is generally opposite the downward direction. In one or more embodiments, the upward direction and the downward direction are both generally orthogonal to an XY plane defined by the forward direction and the rightward direction. In one or more embodiments, the forward direction is generally opposite the rearward direction. In one or more embodiments, the forward direction and the rearward direction are both generally orthogonal to a ZX plane defined by the upward direction and the rightward direction. In one or more embodiments, the rightward direction is generally opposite the port direction. In one or more embodiments, rightward direction and the port direction are both generally orthogonal to a ZY plane defined by the upward direction and the forward direction. Various direction-indicating terms are used herein as a convenient way to discuss the objects shown in the figures. It will be appreciated that many direction indicating terms are related to the instant orientation of the object being described. It will also be appreciated that the objects described herein may assume various orientations without deviating from the spirit and scope of this detailed description. Accordingly, direction-indicating terms such as “upwardly,” “downwardly,” “forwardly,” “backwardly,” “leftwardly,” and “rightwardly,” should not be interpreted to limit the scope of the invention recited in the attached claims.

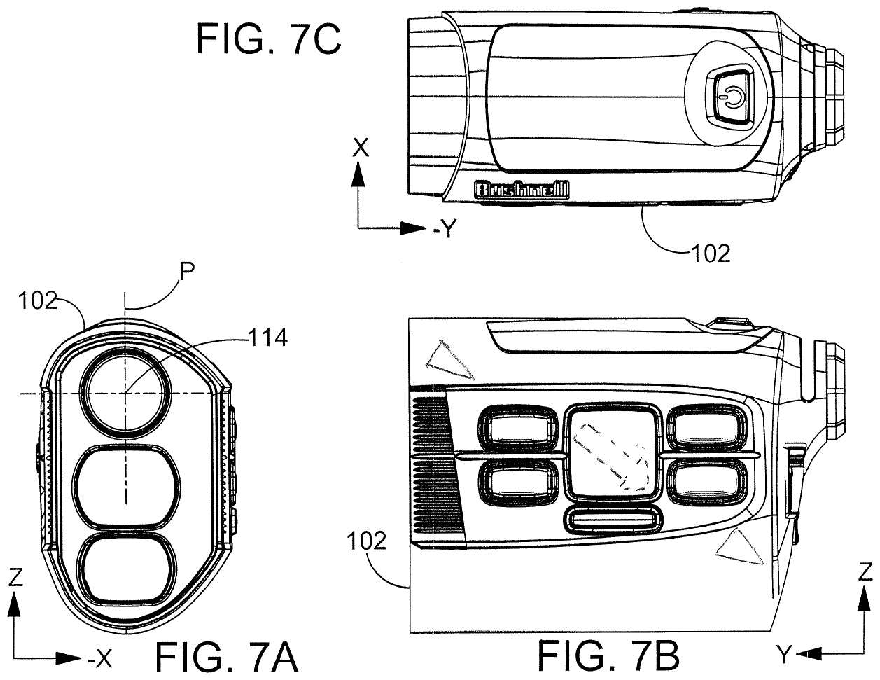

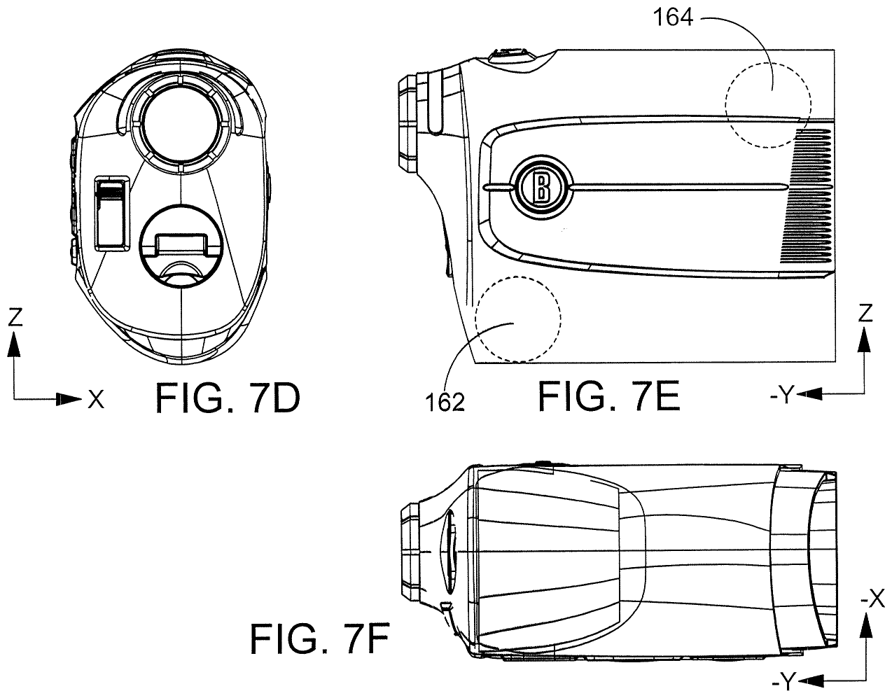

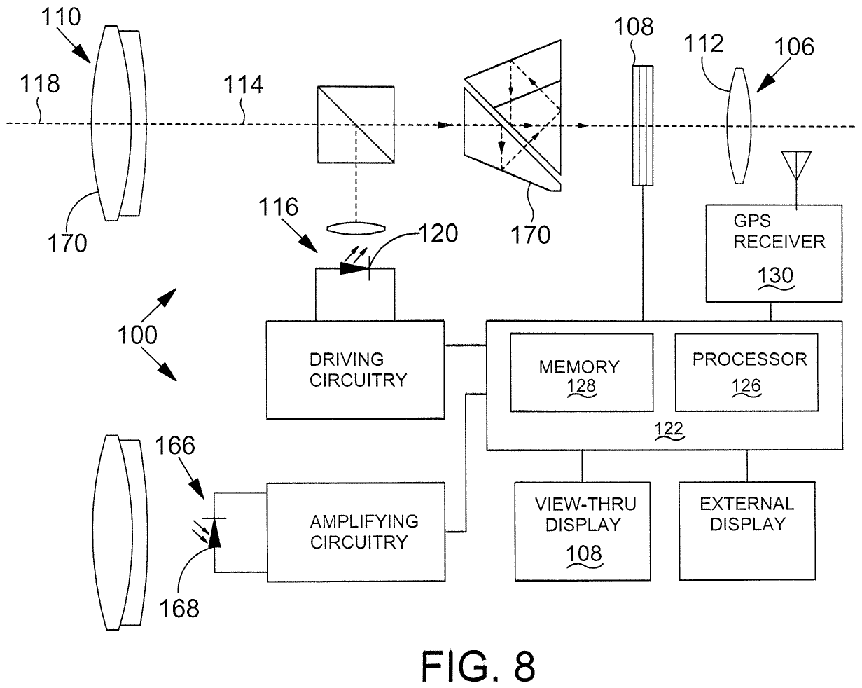

FIG. 7A through FIG. 7F are elevation and plan views showing six sides of a laser rangefinder having a housing 102. The process used to create views showing six sides of a three dimensional object may be referred to as multiview projection or orthographic projection. It is customary to refer to multiview projections using terms such as front view, right side view, top view, rear view, left side view, and bottom view. In accordance with this convention, FIG. 7A may be referred to as a front view of the housing 102, FIG. 7B may be referred to as a right side view of the housing 102, and FIG. 7C may be referred to as a top view of the housing 102. FIG. 7A through FIG. 7F may be referred to collectively as FIG. 7. Terms such as front view and right side view are used herein as a convenient method for differentiating between the views shown in FIG. 7. It will be appreciated that the elements shown in FIG. 7 may assume various orientations without deviating from the spirit and scope of this detailed description. Accordingly, the terms front view, right side view, top view, rear view, left side view, bottom view, and the like should not be interpreted to limit the scope of the invention recited in the attached claims. FIG. 7D may be referred to as a rear view of the housing 102, FIG. 7E may be referred to as a left side view of the housing 102, and FIG. 7F may be referred to as a bottom view of the housing 102.

Referring to FIG. 7A, the housing 102 of the laser rangefinder has a shape that is asymmetric about a plane P in some embodiments. The plane P intersects an optical axis 114 in some embodiments. The plane P extends in upward, downward, forward and rear ward directions in some embodiments. Referring to FIGS. 7A, 7B and 7E, the housing 102 of the laser rangefinder, in some embodiments, defines a right side recess and a left side recess. Referring to FIG. 7B, the housing 102 of the laser rangefinder supports an external display and a plurality of buttons in some embodiments. In embodiments, one button is located below the external display. In embodiments, two buttons are located forward of the external display. In embodiments, two buttons are located rearward of the external display.

The following United States patents are hereby incorporated by reference herein: U.S. Pat. Nos. 9,535,162, 9,518,804, 9,494,686, 9,482,489, 9,429,653, 9,400,326, 9,383,448, 9,335,415, 9,322,920, 9,295,895, 9,274,202, 9,213,101, 9,212,868, 9,197,763, 9,151,603, 9,127,910, 9,095,761, 9,068,795, 9,038,901, 9,030,651, 8,959,823, 8,909,470, 8,868,342, 8,786,837, 8,708,841, 8,638,423, 8,605,259, 8,599,362, 8,529,380, 8,477,290, 8,411,257, 8,384,884, 8,355,869, 8,314,923, 8,240,186, 8,172,702, 8,081,300, 8,072,583, 8,070,629, 8,070,628, 8,040,758, 8,020,769, 8,018,580, 7,973,912, 7,942,762, 7,922,606, 7,898,647, 7,859,650, 7,713,148, 7,684,017, 7,658,031, 7,571,052, 7,535,553, 7,508,497, 7,414,707, 7,349,073, 7,239,377, 7,118,498, 7,053,992, 6,978,676, 6,934,012, 6,873,406, 6,862,084, 6,819,495, 6,717,654, 6,583,860, 6,529,827, 6,456,938, 6,433,860, 6,263,279, 6,252,655, 6,171,199, 6,144,308, 6,133,992, 6,108,071, 6,073,352, 6,029,121, 6,023,322, 5,953,109, 5,926,260, 5,926,259, 5,903,996, 5,898,484, 5,810,680, 5,703,678, 5,652,651, 5,623,335, 5,616,903, 5,364,093, 5,311,271, 5,283,732, 5,262,837, 5,046,839, 4,136,394, 8,797,511, and 8,909,470. Components illustrated in such patents may be utilized with embodiments herein. Incorporation by reference is discussed, for example, in MPEP section 2163.07(B).

The above references in all sections of this application are herein incorporated by references in their entirety for all purposes.

All of the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

What is claimed is:

1. A golf laser rangefinder comprising:
a housing defining a cavity, the housing including a pair of opposing side wall portions, one of the side wall portions defining a pair of circular pockets, each of the opposing side wall portions being generally rectangular and wherein the circular pockets positioned at opposing corners of the one of the rectangular side wall portion;
a pair of magnets comprising a first magnet received in the first pocket and a second magnet received in the second pocket, the magnets not exteriorly exposed on the housing;
an objective optic supported by the housing, the objective optic comprising one or more objective lenses;
an eyepiece optic supported by the housing, the eyepiece optic comprising one or more eyepiece lenses;
a view-thru display assembly disposed along an optical path between the objective optic and the eyepiece optic, the view-thru display assembly being disposed rearward of the objective optic and the eyepiece optic being disposed rearward of the view-thru display assembly so that a scene or subject can be viewed through the eyepiece optic and a plurality of display elements selectively displayed by the view-thru display assembly are superimposed on the scene or subject being viewed;
a laser source for generating a laser beam, the laser beam extending along a laser beam axis, the laser source being operatively coupled to the control circuitry; and
a photo detector electrically connected an amplifying circuitry, the amplifying circuitry being operatively coupled to the control circuitry.

2. The golf laser rangefinder of claim 1, wherein the side wall portion opposite the side wall portion has a display screen and a plurality of control buttons for providing ranging data.

3. The golf laser rangefinder of claim 2 wherein the display screen and plurality of control button are operable when the laser rangefinder is mounted on a upright ferromagnetic post by way of the pair of magnets.

4. The golf laser rangefinder of claim 1, wherein the side wall portion defining the first pocket and the second pocket on a starboard side of the housing and the display screen and control buttons are on a port side of the housing.

5. The golf laser rangefinder of claim 1, wherein the first and second pockets are facing inwardly.

6. The golf laser rangefinder of claim 4 further comprising an orientation sensor for detecting a present orientation of the housing, wherein a display on the display screen reflects the present orientation.

7. A golf laser rangefinder capable of magnetic attachment to a ferromagnetic surface, the golf laser rangefinder comprising:
a housing defining a cavity, the housing including a pair of opposing housing side wall portions, one of the side wall portions having a magnetic attraction region traversing the one of the pair of side wall portions;
one of an elongate magnet or a plurality of circular magnets secured on the side wall portion at the magnetic attraction region;
an objective optic supported by the housing, the objective optic comprising one or more objective lenses;
an eyepiece optic supported by the housing, the eyepiece optic comprising one or more eyepiece lenses;
a view-thru display assembly disposed along an optical path between the objective optic and the eyepiece optic, the view-thru display assembly being disposed rearward of the objective optic and the eyepiece optic being disposed rearward of the view-thru display assembly so that a scene or subject can be viewed through the eyepiece optic and a plurality of display elements selectively displayed by the view-thru display assembly are superimposed on the scene or subject being viewed;
a laser source for generating a laser beam, the laser beam extending along a laser beam axis, the laser source being operatively coupled to the control circuitry; and
a photo detector electrically connected an amplifying circuitry, the amplifying circuitry being operatively coupled to the control circuitry.

8. The golf laser rangefinder of claim 7, wherein the one of the side wall portions having the magnetic attraction region has a plurality of interior pockets on said side wall and the plurality of interior pockets have magnets contained therein.

9. The golf laser rangefinder of claim 7, wherein the one of the side wall portions having the magnetic attraction region has one or more exterior facing pockets on said side wall portion and each of the one or more exterior pockets has a magnet seated and fixed therein.

10. The golf laser rangefinder of claim 9, wherein the one of the side wall portions has an elongate rectangular pocket and a elongate rectangular magnet is seated and fixed therein.

11. The golf laser rangefinder of claim 9, wherein a plurality of circular magnets extend along the magnetic attraction region.

12. The golf laser rangefinder of claim 11, wherein the magnetic attraction region extends diagonally across the respective side wall portion.

13. The golf laser rangefinder of claim 7, wherein the side wall portion defining the first pocket and the second pocket is a starboard side wall portion and the side wall portion defining the display window is a port side wall portion.

14. The golf laser rangefinder of claim 7, wherein one of the side wall portions includes a direction indicating element for indicating a desirable orientation for the golf laser rangefinder to assume when stowed.

15. The golf laser rangefinder of claim 7, wherein the other of the side wall portions includes an electronic display window for displaying ranging distances, the display viewable by a passenger when the laser rangefinder is placed in a stowed position on a golf cart forward roof support member.

16. The golf laser rangefinder of claim 15 wherein each of the side wall portions is rectangular and the magnetic attraction region extends diagonally from a corner to a corner of the one of the side wall portions.

17. A golf laser rangefinder capable of magnetic attachment to a ferromagnetic surface, the golf laser rangefinder comprising:
a housing defining a cavity, the housing including a pair of opposing housing side wall portions, one of the side wall portions having a magnetic attraction region diagonally traversing the one of the pair of side wall portions and an electronic display panel and a plurality of control buttons on the opposite one of the pair of side wall portions;
one of an elongate magnet or a plurality of magnets secured on the side wall portion at the magnetic attraction region;
an objective optic supported by the housing, the objective optic comprising one or more objective lenses;
an eyepiece optic supported by the housing, the eyepiece optic comprising one or more eyepiece lenses;
a view-thru display assembly disposed along an optical path between the objective optic and the eyepiece optic, the view-thru display assembly being disposed rearward of the objective optic and the eyepiece optic being disposed rearward of the view-thru display assembly so that a scene or subject can be viewed through the eyepiece optic and a plurality of display elements selectively displayed by the view-thru display assembly are superimposed on the scene or subject being viewed;
a laser source for generating a laser beam, the laser beam extending along a laser beam axis, the laser source being operatively coupled to the control circuitry; and
a photo detector electrically connected an amplifying circuitry, the amplifying circuitry being operatively coupled to the control circuitry.

18. The golf laser rangefinder of claim 17, wherein the side wall portion at the magnetic attraction region has a plurality of inwardly facing circular pockets each with a circular magnet fixed therein.

19. The golf laser rangefinder of claim 18, wherein there are three circular pockets.

20. The golf laser rangefinder of claim 17, wherein the side wall portion at the magnetic attraction region has at least one outwardly facing pocket with a magnet fixed therein.
